(19) United States
(12) Patent Application Publication
(10) Pub. No.: US 2024/0324670 A1
(43) Pub. Date: Oct. 3, 2024

(54) AEROSOL GENERATING DEVICE

(71) Applicant: KT&G CORPORATION, Daejeon (KR)

(72) Inventors: Wonkyeong LEE, Guri-si (KR); Min Kyu Kim, Seoul (KR)

(73) Assignee: KT&G CORPORATION, Daejeon (KR)

(21) Appl. No.: 18/424,388

(22) Filed: Jan. 26, 2024

(30) Foreign Application Priority Data
Mar. 31, 2023 (KR) 10-2023-0042924
Jun. 15, 2023 (KR) 10-2023-0076550

(51) Int. Cl. A24F 40/42; A24F 40/46; A24F 40/51; A24F 40/65; H05B 6/66

(52) U.S. Cl. CPC A24F 40/42; A24F 40/46; A24F 40/51; A24F 40/65; H05B 6/668

(57) ABSTRACT

An aerosol generating device includes a housing including a first surface, a second surface opposite to the first surface, a side surface between the first surface and the second surface, and a mouthpiece formed on the first surface, an oscillator accommodated in the housing and configured to generate a microwave with a preset frequency, a resonator accommodated in the housing and configured to resonate the microwave to generate an amplified electromagnetic field, and a cartridge including an aerosol generating material and being insertable into the housing, wherein an aerosol may be generated as at least a portion of the electromagnetic field heats the aerosol generating material, the housing may be provided with a cartridge insertion hole through which the cartridge is inserted, and the cartridge insertion hole and the mouthpiece may not overlap.

### CROSS-REFERENCE TO RELATED APPLICATION

This application claims the benefit of Korean Patent Application No. 10-2023-0042924 filed on Mar. 31, 2023, and Korean Patent Application No. 10-2023-0076550 filed on Jun. 15, 2023, in the Korean Intellectual Property Office, the entire disclosures of which are incorporated herein by reference for all purposes.

### BACKGROUND

### 1. Field of the Invention

The following embodiments relate to an aerosol generating device.

### 2. Description of the Related Art

Research on non-combusted cigarettes is being carried out. For example, a non-combustion type flavor inhaler, a flavor inhalation component source unit, and an atomizing unit are disclosed in Korean Patent Application Publication No. 10-2017-0132823.

### SUMMARY

An aerosol generating device according to an embodiment is intended to generate an aerosol through microwave dielectric heating.

An aerosol generating device according to an embodiment is intended to implement a cartridge holding an aerosol generating material in various shapes.

An aerosol generating device according to an embodiment is intended to ensure the diversity of aerosol generating materials held in a cartridge.

According to an embodiment, an aerosol generating device includes a housing including a first surface, a second surface opposite to the first surface, a side surface between the first surface and the second surface, and a mouthpiece formed on the first surface, an oscillator accommodated in the housing and configured to generate a microwave with a preset frequency, a resonator accommodated in the housing and configured to resonate the microwave to generate an amplified electromagnetic field, and a cartridge including an aerosol generating material and being insertable into the housing, wherein an aerosol may be generated as at least a portion of the electromagnetic field heats the aerosol generating material, the housing may be provided with a cartridge insertion hole through which the cartridge is inserted, and the cartridge insertion hole and the mouthpiece may not overlap.

In an embodiment, the cartridge insertion hole may be provided in one of the side surface or the second surface of the housing.

In an embodiment, the aerosol generating material may include at least one of cut tobacco leaves, tobacco granules, reconstituted tobacco, or a liquid aerosol forming material containing nicotine.

In an embodiment, the cartridge may include a cartridge body surrounding an outer side of the aerosol generating material, and the cartridge body may include a porous material.

The cartridge may further include a cartridge stopper disposed at one end of the cartridge body, and at least a portion of the cartridge stopper may extend more than the cartridge body, in a direction perpendicular to a direction in which the cartridge stopper and the cartridge body are arranged.

In an embodiment, the resonator may include a first plate and a second plate disposed with the cartridge interposed therebetween.

In an embodiment, the aerosol generating device may further include a controller accommodated in the housing and configured to control an operation of the aerosol generating device, the controller including at least one processor, and a battery accommodated in the housing and configured to supply power to the aerosol generating device.

In an embodiment, the aerosol generating device may further include a shielding portion surrounding the oscillator and the resonator, wherein the shielding portion may be provided with a shielding portion opening through which the cartridge is inserted, and the shielding portion opening and the cartridge insertion hole may be aligned side by side with each other.

In an embodiment, the aerosol generating device may further include an airflow path extending from an airflow inlet formed in one surface of the housing through the cartridge to the mouthpiece.

In an embodiment, the airflow inlet may be formed in the side surface of the housing.

In an embodiment, the airflow inlet may be formed in the second surface of the housing.

According to an embodiment, an aerosol generating device includes a housing including a first surface, a second surface opposite to the first surface, a side surface between the first surface and the second surface, and a mouthpiece formed on the first surface, an oscillator accommodated in the housing and configured to generate a microwave with a frequency in the range of 300 megahertz (MHz) to 300 gigahertz (GHz), a resonator accommodated in the housing and configured to resonate the microwave to generate an amplified electromagnetic field, and a cartridge including an aerosol generating material and being insertable into the housing, wherein an aerosol may be generated as at least a portion of the electromagnetic field heats the aerosol generating material, the cartridge may include a cartridge body surrounding an outer side of the aerosol generating material, and the cartridge body may include a porous material.

In an embodiment, the aerosol generating material may include at least one of cut tobacco leaves, tobacco granules, reconstituted tobacco, or a liquid aerosol forming material containing nicotine.

In an embodiment, the housing may be provided with a cartridge insertion hole through which the cartridge is inserted, and the cartridge insertion hole may be provided in one of the side surface or the second surface of the housing.

In an embodiment, the aerosol generating device may further include an airflow path extending from an airflow inlet through the cartridge to the mouthpiece, wherein the airflow inlet may be formed in at least one of the side surface or the second surface of the housing.

Additional aspects of embodiments will be set forth in part in the description which follows and, in part, will be apparent from the description, or may be learned by practice of the disclosure.

According to embodiments, it is possible to generate an aerosol through microwave dielectric heating.

According to embodiments, it is possible to implement a cartridge holding an aerosol generating material in various shapes.

According to embodiments, it is possible to ensure the diversity of aerosol generating materials held in a cartridge.

The effects of the aerosol generating device according to embodiments are not limited to the above-mentioned effects, and other unmentioned effects can be clearly understood from the following description by one of ordinary skill in the art.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an aerosol generating device according to an embodiment;

FIG. 2 is a block diagram of an aerosol generating device according to an embodiment;

FIG. 3 illustrates a cartridge of an aerosol generating device according to an embodiment;

FIG. 4 illustrates a resonator of an aerosol generating device according to an embodiment; and

FIG. 5 illustrates an airflow path of an aerosol generating device according to an embodiment.

### DETAILED DESCRIPTION

The terms used in the embodiments are selected from among common terms that are currently widely used, in consideration of their function in the embodiments. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

As used herein, an expression such as “at least one of” that precedes listed components modifies not each of the listed components but all the components. For example, the expression “at least one of a, b, or c” should be construed as including a, b, c, a and b, a and c, b and c, or a, b, and c.

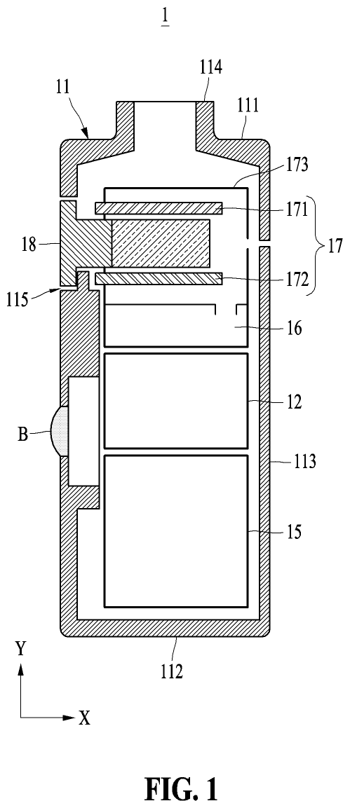

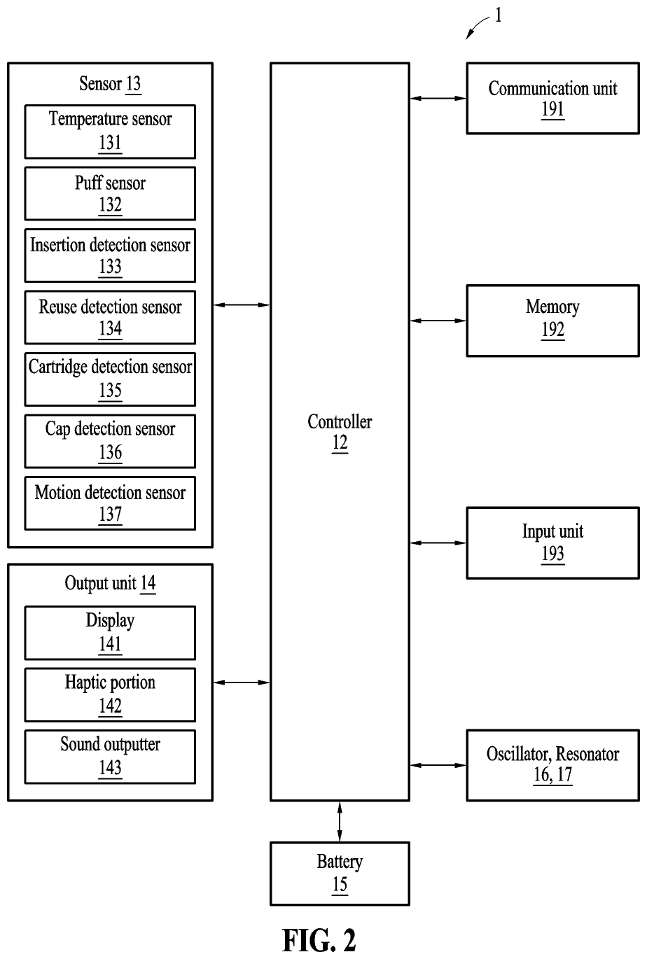

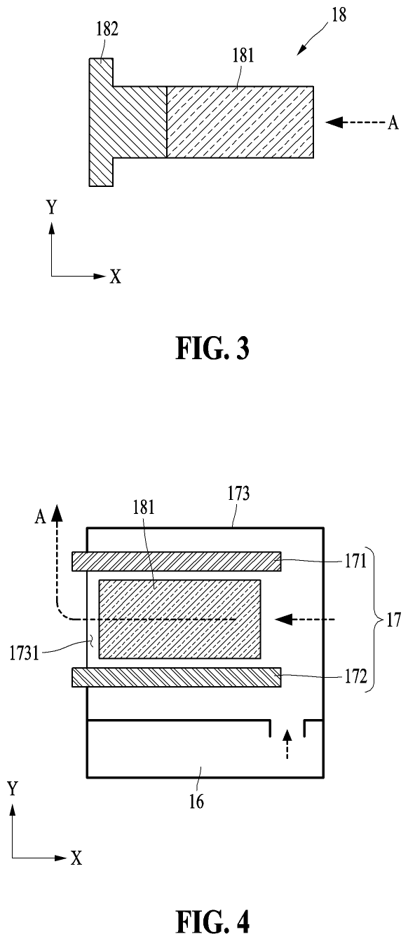

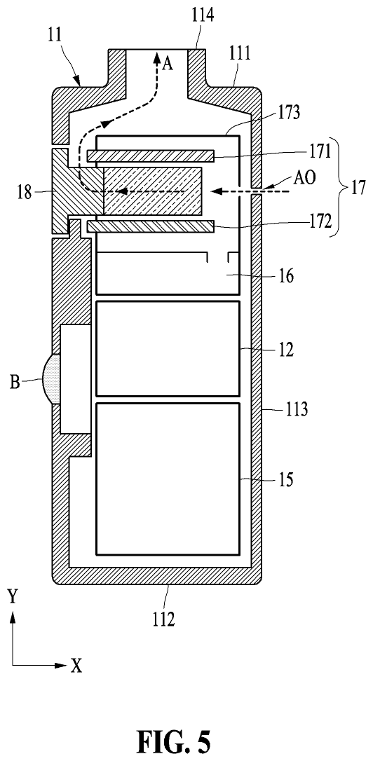

FIG. 1 schematically illustrates an aerosol generating device 1 according to an embodiment, and FIG. 2 is a block diagram of the aerosol generating device 1 according to an embodiment. FIG. 3 illustrates a cartridge 18 of the aerosol generating device 1 according to an embodiment, FIG. 4 illustrates a resonator 17 of the aerosol generating device 1 according to an embodiment, and FIG. 5 illustrates an airflow path A of the aerosol generating device 1 according to an embodiment.

Referring to FIG. 1, the aerosol generating device 1 according to an embodiment may include a housing 11, a controller 12, a battery 15, an oscillator 16, a resonator 17, and a cartridge 18.

An aerosol generating material may be accommodated in the cartridge 18, and an aerosol may be generated by heating the aerosol generating material. A user may smoke by inhaling the generated aerosol. The aerosol generating device 1 may employ a scheme of heating the aerosol generating material using an electromagnetic field generated by resonating a microwave, rather than a scheme of applying heat directly to the aerosol generating material. The above scheme may be called “microwave induction heating.”

In an embodiment, the housing 11 may include a first surface 111, a second surface 112, and a side surface 113, and a mouthpiece 114 may be provided on the first surface 111. The second surface 112 may be a surface opposite to the first surface 111, and the side surface 113 may be a side between the first surface 111 and the second surface 112. The inner space of the housing 11 may be defined by the first surface 111, the second surface 112, and the side surface 113 of the housing 11, and the components of the aerosol generating device 1 described later may be accommodated in the inner space.

In an embodiment, the oscillator 16 and the resonator 17 may be accommodated in the housing 11, the oscillator 16 may generate a microwave with a preset frequency, and the resonator 17 may generate an amplified electromagnetic field by resonating the microwave.

The microwave may be an electromagnetic wave with a frequency of 300 megahertz (MHz) to 300 gigahertz (GHz). In addition, the microwave emitted from the oscillator 16 may be an electromagnetic wave that is emitted omnidirectionally.

For example, the oscillator 16 may include an antenna, and the antenna may be a planar inverted F antenna (PIFA), but is not limited thereto, and may include all devices that may emit a microwave, such as a loop antenna, a monopole antenna, or a dipole antenna. In addition, one or more antennas may be disposed. The antenna may receive an electrical signal from a printed circuit board (PCB) of the controller 12 and emit a microwave. The PCB may be a board that may include electronic components and elements such as an integrated circuit (IC), a resistor, a capacitor, and a switch, and may include wirings that electrically connect the electronic components and elements.

As another example, the oscillator 16 may include a signal source and an amplifier. The signal source of the oscillator 16 may generate a microwave with a preset frequency based on a control signal from the controller 12. The amplifier may amplify the output of the microwave generated by the signal source to an output strong enough to be used to heat the material. The amplifier may adjust the output after the amplifier by adjusting the strength of the signal source based on the signal from the controller 12. For example, the amplitude of the microwave may be reduced or increased. By adjusting the amplitude of the microwave, the power of the microwave may be adjusted.

In order to heat the aerosol generating material, the resonator 17 for forming a high-density microwave may be required. The scheme of transmitting the microwave generated through the source such as the oscillator 16 and supplying the microwave to a medium (e.g., the aerosol generating material) may enable only weak heating and have very low energy efficiency.

The resonator 17 may absorb the microwave with a predetermined frequency emitted from the oscillator 16, and dielectric resonance may be generated by the resonator 17. Dielectric resonance may indicate that resonance is generated by the microwave inside the resonator 17 and the resonator 17 forms an alternating electromagnetic field. The microwave may be resonated by the resonator 17, such that an alternating electromagnetic field may be generated and applied to the aerosol generating material accommodated in the cartridge 18, and the aerosol generating material may be heated and an aerosol may be generated.

Referring to FIG. 2, the aerosol generating device 1 may further include a sensor 13, an output unit 14, a communication unit 191, a memory 192, and an input unit 193. However, the internal structure of the aerosol generating device 1 is not limited to what is shown in FIG. 1 or 2. That is, it is to be understood by one of ordinary skill in the art to which the present embodiment pertains that some of the components shown in FIG. 1 or 2 may be omitted or new components may be added according to the design of the aerosol generating device 1.

The sensor 13 may sense a state of the aerosol generating device 1 or a state of an environment around the aerosol generating device 1, and transmit sensed information to the controller 12. Based on the sensed information, the controller 12 may control the aerosol generating device 1 to control operations of the oscillator 16 and/or the resonator 17, restrict smoking, determine whether the cartridge 18 is inserted, display a notification, and perform other functions.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may sense a temperature at which the resonator 17 heats up. The aerosol generating device 1 may include a separate temperature sensor for sensing the temperature of the resonator 17. The temperature sensor 131 may output a signal corresponding to the temperature of the resonator 17. For example, the temperature sensor 131 may include a resistive element whose resistance value changes in response to a change in the temperature of the resonator 17. The temperature sensor 131 may be implemented by a thermistor, which is an element that uses the property that the resistance changes depending on the temperature. At this time, the temperature sensor 131 may output a signal corresponding to the resistance value of the resistive element as the signal corresponding to the temperature of the resonator 17. For example, the temperature sensor 131 may include a sensor for detecting the resistance value of the resonator 17. At this time, the temperature sensor 131 may output a signal corresponding to the resistance value of the resonator 17 as the signal corresponding to the temperature of the resonator 17.

The temperature sensor 422 may be arranged around the battery 15 to monitor the temperature of the battery 15. The temperature sensor 131 may be disposed adjacent to the battery 15. For example, the temperature sensor 131 may be attached to one surface of the battery 15. For example, the temperature sensor 131 may be mounted on one surface of the PCB.

The temperature sensor 131 may be disposed inside of the housing 11 to sense the internal temperature of the housing 11.

The puff sensor 132 may sense a puff from the user based on various physical changes in an airflow path. The puff sensor 132 may output a signal corresponding to the puff. For example, the puff sensor 132 may be a pressure sensor. The puff sensor 132 may output a signal corresponding to the internal pressure of the aerosol generating device 1. Here, the internal pressure of the aerosol generating device 1 may correspond to the pressure in an airflow path through which a gas flows. The puff sensor 132 may be disposed corresponding to the airflow path through which a gas flows in the aerosol generating device 1.

The insertion detection sensor 133 may sense the insertion and/or removal of the cartridge 18. The insertion detection sensor 133 may sense a signal change according to the insertion and/or removal of the cartridge 18. The insertion detection sensor 133 may be installed in the vicinity of an insertion space. The insertion detection sensor 133 may sense the insertion and/or removal of the cartridge 18 according to a change in the permittivity inside the insertion space. For example, the insertion detection sensor 133 may be an inductive sensor and/or a capacitance sensor.

The inductive sensor may include at least one coil. The coil of the inductive sensor may be disposed adjacent to the insertion space. For example, if the magnetic field changes around the coil through which an electric current flows, the properties of the current flowing through the coil may change according to Faraday's law of electromagnetic induction. Here, the properties of the current flowing through the coil may include the frequency of alternating current, the current value, the voltage value, the inductance value, the impedance value, and the like.

The inductive sensor may output a signal corresponding to the properties of the current flowing through the coil. For example, the inductive sensor may output a signal corresponding to the inductance value of the coil.

The capacitance sensor may include a conductor. The conductor of the capacitance sensor may be disposed adjacent to the insertion space. The capacitance sensor may output a signal corresponding to the electromagnetic properties of the surroundings, for example, the capacitance around the conductor. For example, when the cartridge 18 including a metal material is inserted into the insertion space, the electromagnetic properties around the conductor may change due to the metal material of the cartridge 18.

The reuse detection sensor 134 may sense whether the cartridge 18 is reused. The reuse detection sensor 134 may be a color sensor. The color sensor may sense the color of the cartridge 18. The color sensor may sense the color of a portion of the outside of the cartridge 18. The color sensor may detect a value of the optical properties corresponding to the color of an object based on light reflected from the object. For example, the optical properties may be the wavelength of light. The color sensor may be implemented as a single component in conjunction with a proximity sensor, or may be implemented as a separate component different from the proximity sensor.

When the color of a portion of the outside of the cartridge 18 changes due to an aerosol, the reuse detection sensor 134 may be disposed at a position corresponding to the position at which the portion of the outside of the cartridge 18 that changes in color due to an aerosol is disposed as the cartridge 18 is inserted into a cartridge accommodation space. For example, before the cartridge 18 is used by the user, the color of the portion of the outside of the cartridge 18 may be a first color. At this time, as the portion of the outside of the cartridge 18 is wet by the aerosol while the aerosol generated by the aerosol generating device 1 passes through the cartridge 18, the color of the portion of the outside of the cartridge 18 may change to a second color. Meanwhile, the color of the portion of the outside of the cartridge 18 may be maintained as the second color after changing from the first color to the second color.

The cartridge detection sensor 135 may sense the insertion and/or removal of the cartridge 18. The cartridge detection sensor 135 maybe implemented by an inductance-based sensor, a capacitive sensor, a resistance sensor, or a Hall sensor (e.g., Hall IC) using the Hall effect.

The cap detection sensor 136 may sense the mounting and/or removal of a cap. When the cap is detached from the housing 11, a portion of the cartridge 18 and the housing 11 covered by the cap may be exposed to the outside. The cap detection sensor 136 may be implemented by a contact sensor, a Hall sensor (e.g., Hall IC), an optical sensor, or the like.

The motion detection sensor 137 may sense a motion of the aerosol generating device 1. The motion detection sensor 137 may be implemented by at least one of an acceleration sensor and a gyro sensor.

In addition to the sensors 131 to 137 described above, the sensor 13 may further include at least one of a humidity sensor, a barometric pressure sensor, a magnetic sensor, a position sensor (e.g., global positioning system (GPS)), and a proximity sensor. A function of each of the sensors may be intuitively inferable from its name by one of ordinary skill in the art, and thus, a more detailed description thereof will be omitted here.

The output unit 14 may output and provide information about the state of the aerosol generating device 1 to the user. The output unit 14 may include at least one of a display 141, a haptic portion 142, or a sound outputter 143, but is not limited thereto. When the display 141 and a touchpad are provided in a layered structure to form a touchscreen, the display 141 may be used as an input device in addition to an output device.

The display 141 may visually provide information about the aerosol generating device 1 to the user. The information about the aerosol generating device 1 may include, for example, a charging/discharging state of the battery 15 of the aerosol generating device 1, a preheating state of the heater 18, an insertion/removal state of the cartridge 18, a mounting/removal state of the cap, or a limited usage state (e.g., an abnormal article detected) of the aerosol generating device 1, or the like, and the display 141 may externally output the information. For example, the display 141 may be in a form of a light-emitting diode (LED) device. The display 141 may be, for example, a liquid-crystal display panel (LCD), an organic light-emitting display panel (OLED), or the like.

The haptic portion 142 may provide information about the aerosol generating device 1 to the user in a haptic way by converting an electrical signal into a mechanical stimulus or an electrical stimulus. For example, the haptic portion 142 may generate vibrations corresponding to the completion of initial preheating when initial power is supplied to the oscillator 16 and/or the resonator 17 for a set time. The haptic portion 142 may include, for example, a vibration motor, a piezoelectric element, or an electrical stimulation device.

The sound outputter 143 may provide the information about the aerosol generating device 1 to the user in an auditory way. For example, the sound outputter 143 may convert an electrical signal into a sound signal and externally output the sound signal.

The battery 15 may supply power to be used to operate the aerosol generating device 1. The battery 15 may supply power to the oscillator 16 and/or the resonator 17. In addition, the battery 15 may supply power required for operations of the other components (e.g., the sensor 13, the output unit 14, the communication unit 191, the memory 192, and the input unit 193) included in the aerosol generating device 1. The battery 15 may be a rechargeable battery or a disposable battery. The battery 15 may be, for example, a lithium polymer (LiPoly) battery, but is not limited thereto.

Although not shown in FIG. 1, the aerosol generating device 1 may further include a power protection circuit. The power protection circuit may be electrically connected to the battery 15 and may include a switching element.

The power protection circuit may cut off an electrical path for the battery 15 under a predetermined condition. For example, the power protection circuit may cut off the electrical path for the battery 15 when the voltage level of the battery 15 is greater than or equal to a first voltage corresponding to overcharging. For example, the power protection circuit may cut off the electrical path for the battery 15 when the voltage level of the battery 15 is less than a second voltage corresponding to overdischarging.

The input unit 15 may receive information input from the user or may output information to the user. For example, the input unit 15 may be a touch panel. The touch panel may include at least one touch sensor for sensing a touch. For example, the touch sensor may include a capacitive touch sensor, a resistive touch sensor, a surface acoustic wave touch sensor, an infrared touch sensor, and the like, but is not limited thereto.

The display 141 and the touch panel may be implemented as a single panel. For example, the touch panel may be inserted into the display 141 (e.g., an on-cell type or in-cell type). For example, the touch panel may be added onto the display panel 141 (e.g., an add-on type).

Meanwhile, the input unit 15 may include a button, a keypad, a dome switch, a jog wheel, a jog switch, and the like, but is not limited thereto.

The memory 192, which is hardware for storing various pieces of data processed in the aerosol generating device 1, may store data processed by the controller 12 and data to be processed thereby. The memory 192 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 192 may store an operating time of the aerosol generating device 1, a maximum number of puffs, a current number of puffs, at least one temperature profile, data associated with a smoking pattern of the user, and the like.

The communication unit 16 may include at least one component for communicating with another electronic device. For example, the communication unit 16 may include at least one of a short-range wireless communication unit and a wireless communication unit.

The short-range wireless communication unit may include a Bluetooth communication unit, a Bluetooth low energy (BLE) communication unit, a near-field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit, but is not limited thereto.

The wireless communication unit may include, for example, a cellular network communicator, an Internet communicator, a computer network (e.g., a local area network (LAN) or a wide-area network (WAN)) communicator, and the like, but is not limited thereto.

Although not shown in FIG. 1, the aerosol generating device 1 may further include a connection interface such as a universal serial bus (USB) interface, and may be connected to another external device through the connection interface such as a USB interface to transmit and receive information or to charge the battery 15.

The controller 12 may control the overall operation of the aerosol generating device 1. In an embodiment, the controller 12 may include at least one processor. The at least one processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

The controller 12 may control the temperature of the heater 18 by controlling the supply of power from the battery 15 to the heater 18. The controller 12 may control the temperature of the cartridge heater 24 and/or the heater 18 based on the temperature of the cartridge heater 24 and/or the heater 18 sensed by the temperature sensor 131. The controller 12 may adjust the power supplied to the cartridge heater 24 and/or the heater 18 based on the temperature of the cartridge heater 24 and/or the heater 18. For example, the controller 12 may determine a target temperature for the cartridge heater 24 and/or the heater 18 based on a temperature profile stored in the memory 192.

The aerosol generating device 1 may include a power supply circuit (not shown) electrically connected to the battery 15 between the battery 15 and the oscillator 16 and/or the resonator 17. The power supply circuit may be electrically connected to the oscillator 16 and/or the resonator 17. The power supply circuit may contain at least one switching element. The switching element may be implemented by a bipolar junction transistor (BJT), a field effective transistor (FET), or the like. The controller 12 may control the power supply circuit.

The controller 12 may control the power supply by controlling the switching of the switching element of the power supply circuit. The power supply circuit may be an inverter for converting direct current power output from the battery 15 into alternating current power. For example, the inverter may be configured as a half-bridge circuit or a full-bridge circuit including a plurality of switching elements.

The controller 12 may turn on the switching element to supply power from the battery 15 to the cartridge heater 24 and/or the heater 18. The controller 12 may turn off the switching element to cut off the supply of power to the cartridge heater 24 and/or the heater 18. The controller 12 may adjust the current supplied from the battery 15 by adjusting the frequency and/or duty ratio of the current pulse input to the switching element.

The controller 12 may control the voltage output from the battery 15 by controlling the switching of the switching element of the power supply circuit. A power conversion circuit may convert the voltage output from the battery 15. For example, the power conversion circuit may include a buck-converter for decreasing the voltage output from the battery 15. For example, the power conversion circuit may be implemented through a buck-boost converter, a Zener diode, or the like.

The controller 12 may adjust the level of voltage output from the power conversion circuit by controlling an ON/OFF operation of the switching element included in the power conversion circuit. During the ON state of the switching element, the level of voltage output from the power conversion circuit may correspond to the level of voltage output from the battery 15. The duty ratio for the ON/OFF operation of the switching element may correspond to the ratio of the voltage output from the power conversion circuit to the voltage output from the battery 15. As the duty ratio for the ON/OFF operation of the switching element decreases, the level of voltage output from the power conversion circuit may decrease. The heater 18 may be heated based on the voltage output from the power conversion circuit.

The controller 12 may be controlled to supply power to the heater 18 using at least one of a pulse width modulation (PWM) scheme and a proportional-integral-differential (PID) scheme.

For example, the controller 12 may be controlled to supply a current pulse with a predetermined frequency and a duty ratio to the heater 18, using the PWM scheme. The controller 12 may control the power supplied to the heater 18 by adjusting the frequency and duty ratio of the current pulse.

For example, the controller 12 may determine a target temperature, the target of the controlling, based on the temperature profile. The controller 12 may control the power supplied to the heater 18 using the PID scheme, which is a feedback control scheme through the difference value between the temperature of the heater 18 and the target temperature, the value obtained by integrating the difference value over time, and the value obtained by differentiating the difference value over time.

The controller 12 may prevent overheating of the oscillator 16 and/or the resonator 17. For example, the controller 12 may control the operation of the power conversion circuit to stop supplying power to the oscillator 16 and/or the resonator 17 based on the temperature of the oscillator 16 and/or the resonator 17 exceeding a preset temperature limit. For example, the controller 12 may reduce the amount of power supplied to the oscillator 16 and/or the resonator 17 by a predetermined proportion, based on the temperature of the oscillator 16 and/or the resonator 17 exceeding the preset temperature limit.

The controller 12 may control the charging and discharging of the battery 15. The controller 12 may verify the temperature of the battery 15 based on an output signal from the temperature sensor 131.

When a power line is connected to a battery terminal of the aerosol generating device 1, the controller 12 may verify whether the temperature of the battery 15 is greater than or equal to a first temperature limit which is the criterion for cutting off the charging of the battery 15. The controller 12 may control the battery 15 to be charged based on a preset charging current when the temperature of the battery 15 is less than the first temperature limit. The controller 12 may cut off the charging of the battery 15 when the temperature of the battery 15 is greater than or equal to the first temperature limit.

In a state in which the aerosol generating device 1 is powered on, the controller 12 may verify whether the temperature of the battery 15 is greater than or equal to a second temperature limit which is the criterion for cutting off the discharging of the battery 15. The controller 12 may control the power stored in the battery 15 to be used when the temperature of the battery 15 is less than the second temperature limit. The controller 12 may stop using the power stored in the battery 15 when the temperature of the battery 15 is greater than or equal to the second temperature limit.

The controller 12 may calculate the remaining capacity for the power stored in the battery 15. For example, the controller 12 may calculate the remaining capacity of the battery 15 based on the voltage of the battery 15 and/or the value of current sensed.

The controller 12 may determine whether the cartridge 18 is inserted into the insertion space through the insertion detection sensor 133. The controller 12 may determine that the cartridge 18 is inserted based on an output signal from the insertion detection sensor 133. When it is determined that the cartridge 18 is inserted into the insertion space, the controller 12 may be controlled to supply power to the oscillator 16 and/or the resonator 17. For example, the controller 12 may supply power to the oscillator 16 and/or the resonator 17 based on the temperature profile stored in the memory 192.

The controller 12 may determine whether the cartridge 18 is removed from the insertion space. For example, the controller 12 may determine whether the cartridge 18 is removed from the insertion space through the insertion detection sensor 133. For example, the controller 12 may determine that the cartridge 18 is removed from the insertion space when the temperature of the oscillator 16 and/or the resonator 17 is greater than or equal to a temperature limit or when the gradient of the temperature change of the oscillator 16 and/or the resonator 17 is greater than or equal to a set gradient. When it is determined that the cartridge 18 is removed from the insertion space, the controller 12 may cut off the supply of power to the oscillator 16 and/or the resonator 17.

The controller 12 may control the time of power supply and/or the amount of power supply to the oscillator 16 and/or the resonator 17 depending on the state of the cartridge 18 sensed by the sensor 13. The controller 12 may verify a level range including the level of a signal of the capacitance sensor based on a lookup table. The controller 12 may determine the amount of moisture in the cartridge 18 according to the verified level range.

When the cartridge 18 is in an over-humidified state, the controller 12 may increase the preheating time of the cartridge 18 compared to the case in which the cartridge is in a normal state, by controlling the time of power supply to the oscillator 16 and/or the resonator 17.

The controller 12 may determine whether the cartridge 18 inserted into the insertion space is reused through the reuse detection sensor 134. For example, the controller 12 may compare a sensed value of a signal of the reuse detection sensor 134 with a first reference range including a first color, and when the sensed value falls within the first reference range, determine that the cartridge 18 is unused. For example, the controller 12 may compare the sensed value of the signal of the reuse detection sensor 134 with a second reference range including a second color, and when the sensed value falls within the second reference range, determine that the cartridge 18 is used. When it is determined that the cartridge 18 is used, the controller 12 may cut off the supply of power to the oscillator 16 and/or the resonator 17.

The controller 12 may perform a determination about the inhalation of the user through the puff sensor 132. For example, the controller 12 may determine whether a puff occurs based on a sensed value of a signal of the puff sensor 132. For example, the controller 12 may determine the strength of the puff based on the sensed value of the signal of the puff sensor 132. When the number of puffs reaches a preset maximum number of puffs or when a puff is not detected for more than a preset time, the controller 12 may cut off the supply of power to the oscillator 16 and/or the resonator 17.

The controller 12 may determine whether the cap is put on and/or taken off, through the cap detection sensor 136. For example, the controller 12 may determine whether the cap is put on and/or taken off based on a sensed value of a signal of the cap detection sensor 136.

The controller 12 may control the output unit 14 based on a result of sensing by the sensor 13. For example, when the number of puffs counted through the puff sensor 132 reaches the preset number, the controller 12 may inform the user that the aerosol generating device 1 is to be ended soon, through at least one of the display 141, the haptic portion 142, or the sound outputter 143. For example, the controller 12 may provide information to the user through the output unit 14 based on the determination that the cartridge 18 is absent from the insertion space. For example, the controller 12 may provide information to the user through the output unit 14 based on the determination that the cartridge 18 and/or the cap is not mounted. For example, the controller 12 may provide information on the temperature of the oscillator 16 and/or the resonator 17 to the user through the output unit 14.

Based on the occurrence of a predetermined event, the controller 12 may store and update the history of the event that occurred in the memory 192. The event may include the detection of inserting the cartridge 18, the initiation of heating the cartridge 18, the detection of puffs, the end of puffs, the detection of overheating of the oscillator 16 and/or the resonator 17, the detection of applying overvoltage to the oscillator 16 and/or the resonator 17, the end of heating the cartridge 18, the operation of powering ON/OFF the aerosol generating device 1, initiation of charging the battery 15, the detection of overcharging of the battery 15, the end of charging the battery 15, or the like, performed by the aerosol generating device 1. The history of the event may include the date and time the event occurred, log data corresponding to the event, and the like. For example, if the predetermined event is the detection of inserting the cartridge 18, the log data corresponding to the event may include data on the sensed value of the insertion detection sensor 133. For example, if the predetermined event is the detection of overheating of the oscillator 16 and/or the resonator 17, the log data corresponding to the event may include data on the temperature of the oscillator 16 and/or the resonator 17, the voltage applied to the oscillator 16 and/or the resonator 17, the current flowing in the oscillator 16 and/or the resonator 17, and the like.

The controller 12 may be controlled to form a communication link with an external device, such as a mobile terminal of the user. When authentication data is received from the external device via the communication link, the controller 12 may remove restrictions on the use of at least one function of the aerosol generating device 1. Here, the authentication data may include data indicating the completion of user authentication for the user corresponding to the external device. The user may perform user authentication through the external device. The external device may determine whether user data is valid based on the date of birth of the user, a unique number that identifies the user, and the like, and receive data on the authority to use the aerosol generating device 1 from an external server. The external device may transmit data indicating the completion of user authentication to the aerosol generating device 1 based on the data on the authority to use. In response to the completion of the user authentication, the controller 12 may remove restrictions on the use of at least one function of the aerosol generating device 1. For example, in response to the completion of the user authentication, the controller 12 may remove restrictions on the use of a heating function that supplies power to the oscillator 16 and/or the resonator 17.

The controller 12 may transmit state data of the aerosol generating device 1 to the external device via the communication link with the external device. Based on the received state data, the external device may output the remaining capacity, the operation mode, and the like of the battery 15 of the aerosol generating device 1 through a display of the external device.

The external device may transmit a location search request to the aerosol generating device 1 based on an input that initiates a search for the location of the aerosol generating device 1. When the location search request is received from the external device, the controller 12 may control at least one of output devices to perform an operation corresponding to the location search based on the received location search request. For example, in response to the location search request, the haptic portion 142 may generate vibrations. For example, in response to the location search request, the display 141 may output an object corresponding to the location search and the end of the search.

When firmware data is received from the external device, the controller 12 may be controlled to perform a firmware update. The external device may check the current version of the firmware for the aerosol generating device 1 and determine whether a new version of the firmware is present. When an input that requests a firmware download is received, the external device may receive a new version of firmware data and transmit the new version of firmware data to the aerosol generating device 1. When the new version of firmware data is received, the controller 12 may control to update the firmware of the aerosol generating device 1.

The controller 12 may transmit data on the sensed value of at least one sensor 13 through the communication unit 16 to an external server (not shown), receive a learning model generated by learning the sensed value through machine learning such as deep learning from the external server, and store the learning model. The controller 12 may perform an operation of determining an inhalation pattern of the user, an operation of generating a temperature profile, and the like using the learning model received from the external server. The controller 12 may store, in the memory 192, the sensed value data of at least one sensor 13 and the data used to train an artificial neural network (ANN). For example, the memory 192 may store a database for each component provided in the aerosol generating device 1, weights that form the structure of the ANN, and biases, for training the ANN. The controller 12 may generate at least one learning model that learns the data on the sensed value of at least one sensor 13, the inhalation pattern of the user, the temperature profile, and the like, stored in the memory 192, and is used to determine the inhalation pattern of the user and generate the temperature profile.

Referring back to FIG. 1, the cartridge 18 may include an aerosol generating material and be inserted into the housing 11. The cartridge 18 may be inserted into the inner space of the housing 11 through a cartridge insertion hole 115 formed in one surface of the housing 11.

In an embodiment, the cartridge insertion hole 115 may be formed in a position that does not overlap the mouthpiece 114. For example, when the cartridge insertion hole 115 is formed in the first surface 111 of the housing 11, the cartridge insertion hole 115 may be formed at any one position on the circumference of the mouthpiece 114. As another example, the cartridge insertion hole 115 may be formed in the side surface 113 or the second surface 112 of the housing 11.

In particular, referring to FIGS. 1 and 3, the cartridge 18 may include a cartridge body 181 surrounding the outer side of the aerosol generating material and a cartridge stopper 182 disposed at one end of the cartridge body 181.

The cartridge body 181 may include an outer shell to accommodate the aerosol generating material therein, and the outer shell may include a porous material. For example, the cartridge body 181 may have a square pouch shape, allowing free inflow and outflow of air through the outer shell including a porous material, while preventing leakage of the aerosol generating material accommodated in the cartridge body 181 to the outside. The cartridge body 181 may be in the form of a metal mesh, a plastic mesh, or a fabric mesh, but is not necessarily limited thereto. The cartridge body 181 may be miniaturized according to the shape, and for example, the cartridge body 181 may be provided in a hexahedral shape.

The cartridge body 181 may have a pouch shape and thus, may not need to maintain the stick shape, so that the diversity of the shapes of the resonator 17 may be secured. For example, the cartridge body 181 may be disposed between a first plate 171 and a second plate 172 of the resonator 17 described later. The electromagnetic field generated by the resonator 17 may be easily applied to the aerosol generating material in the cartridge body 181, and the aerosol generated by the heated aerosol generating material may easily escape to the outside of the cartridge body 181.

The cartridge stopper 182 may be formed integrally with the cartridge body 181, and the cartridge stopper 182 may serve as a guide and a stopper when the cartridge 18 is inserted into the housing 11 through the cartridge insertion hole 115. For example, an end portion of the cartridge stopper 182 may have a more extended section than the cartridge body 181. At least a portion of the cartridge stopper 182 may extend more than the outer shape of the cartridge body 181 in a direction perpendicular to the direction in which the cartridge body 181 and the cartridge stopper 182 are arranged, that is, in a direction (e.g., in the ±Y direction in FIG. 3) perpendicular to the direction in which the cartridge body 181 is inserted into the housing 11. As the extending section of the cartridge stopper 182 is caught by at least a portion of the cartridge insertion hole 115, the cartridge 18 may be guided to an accommodating position in the housing 11 and thereby stopped at a designated position.

In an embodiment, the aerosol generating material may include a medium and/or a liquid composition. For example, the medium may include at least one of cut tobacco leaves, tobacco granules, or reconstituted tobacco. The reconstituted tobacco may be divided into slurry-type reconstituted tobacco sheets and paper-like reconstituted tobacco sheets according to its manufacturing method. The liquid composition may include aerosol formers such as glycerin and propylene glycol. Further, the liquid composition may include water, a solvent, ethanol, a plant extract, a fragrance, a flavoring agent, or a vitamin mixture. The fragrance may include menthol, peppermint, spearmint oil, various fruit flavor ingredients, and the like, but is not limited thereto. The flavoring agent may include ingredients that provide a user with a variety of flavors or scents. The vitamin mixture may be a mixture of at least one of vitamin A, vitamin B, vitamin C, or vitamin E, but is not limited thereto.

In an embodiment, the aerosol generating material may include a liquid aerosol forming material. The liquid aerosol forming material may include a liquid composition based on nicotine, tobacco extracts, and/or various flavoring agents. However, the scope of the disclosure is not limited to these examples.

In particular, referring to FIGS. 1 and 4, the resonator 17 may include the first plate 171 and the second plate 172 disposed with at least a portion of the cartridge 18 interposed therebetween. The first plate 171 or the second plate 172 may be a plate resonator and may have a shape corresponding to the outer shape of the cartridge body 181. For example, when the cartridge body 181 has a hexahedral shape, the first plate 171 and the second plate 172 may have a plate shape. As another example, when the cartridge body 181 has a cylindrical curved surface, the first plate 171 and the second plate 172 may have a curved plate shape surrounding the cartridge body 181.

In an embodiment, the aerosol generating device 1 may further include a shielding portion 173 (e.g., a shield can) surrounding the oscillator 16 and the resonator 17. The shielding portion 173 may shield a microwave so that the microwave may not be emitted to the outside. The shielding portion 173 may include a metal material with high electrical conductivity. When a microwave is incident to a metal with high electrical conductivity, the microwave may be canceled due to the free electrons present in the metal. The shielding portion 173 may prevent the microwave from being emitted to the outside of the aerosol generating device 1 and reaching the user.

The shielding portion 173 may be provided with a shielding portion opening 1731 through which the cartridge body 181 of the cartridge 18 is to be inserted. On the side adjacent to the shield portion opening 1731 (e.g., the side in the +X direction in FIG. 4), the first plate 171 and the second plate 172 may be arranged to be spaced apart from each other. The shield portion opening 1731 and the cartridge insertion hole 115 may be aligned side by side with each other. For example, on the adjacent side of the cartridge insertion hole 115 (e.g., the side in the +X direction in FIG. 1), the shield portion opening 1731 may be disposed. As the cartridge insertion hole 115 and the shielding portion opening 1731 are aligned side by side with each other, the cartridge body 181 may be easily inserted into the housing 11 without constraints.

Referring to FIG. 5, the aerosol generating device 1 may include an airflow path A, and the airflow path A may extend from an airflow inlet AO formed in one side of the housing 11 through the cartridge 18 to the mouthpiece 114. The air introduced from the outside of the aerosol generating device 1 through the airflow path A may be transferred along with the aerosol to the user through the mouthpiece 114 while passing through the cartridge 18.

In an embodiment, the airflow inlet AO may be formed in the side surface 113 of the housing 11.

For example, the airflow inlet AO and the cartridge insertion hole 115 may be formed in opposite side surfaces 113. The external airflow may be introduced in a first direction (e.g., the −X direction in FIG. 5) through the airflow inlet AO and transfer the aerosol while passing through the cartridge body 181. The airflow, along with the aerosol, may then divert to a second direction (e.g., in the +Y direction in FIG. 5) and be directed to the mouthpiece 114.

As another example, the airflow inlet AO and the cartridge insertion hole 115 may be formed in the same side. In this case, the airflow inlet AO may be provided as a gap formed between a portion (e.g., the cartridge stopper 182) of the cartridge 18 and the cartridge insertion hole 115. The external airflow introduced through the airflow inlet AO may be introduced in a third direction (e.g., in the +X direction in FIG. 5), divert to the second direction with the aerosol while passing through the cartridge body 181, and be transferred to the mouthpiece 114.

In an embodiment, the airflow inlet AO may be formed in the second surface 112 of the housing 11. For example, the external airflow may be introduced in the third direction through the airflow inlet AO formed in the second surface 112 and transferred through the cartridge body 181 to the mouthpiece 114.

According to an embodiment, the aerosol generating device 1 may operate as follows. A button B may be provided on the side surface 113 of the housing 11, and the operation of the aerosol generating device 1 may be controlled through the button B. For example, when the operation of the aerosol generating device 1 starts, the preheating process may be performed for about 17 to 20 seconds. Thereafter, an aerosol may be inhaled as a user sucks. The operation of the aerosol generating device 1 may be stopped after a preset number of puffs. When the medium in the cartridge 18 is exhausted, a change in the permittivity may be detected, and generation of microwaves from the oscillator 16 and/or the resonator 17 may be stopped. Along with this, the user may be informed of the exhaustion of the cartridge 18.

According to an embodiment, the aerosol generating device 1 may generate an aerosol by microwave dielectric heating, and at this time, the cartridge 18 holding an aerosol generating material may be implemented in various shapes. According to an embodiment, the diversity of aerosol generating materials held in the cartridge 18 may also be ensured.

The descriptions of the above-described embodiments are merely examples, and it will be understood by one of ordinary skill in the art that various changes and equivalents may be made thereto. Therefore, the scope of the disclosure should be defined by the appended claims, and all differences within the scope equivalent to those described in the claims will be construed as being included in the scope of protection defined by the claims.

What is claimed is:

1. An aerosol generating device comprising:
a housing comprising a first surface, a second surface opposite to the first surface, a side surface between the first surface and the second surface, and a mouthpiece formed on the first surface;
an oscillator accommodated in the housing and configured to generate a microwave with a preset frequency;
a resonator accommodated in the housing and configured to resonate the microwave to generate an amplified electromagnetic field; and
a cartridge comprising an aerosol generating material and being insertable into the housing,
wherein an aerosol is generated as at least a portion of the electromagnetic field heats the aerosol generating material,
the housing is provided with a cartridge insertion hole through which the cartridge is inserted, and
the cartridge insertion hole and the mouthpiece do not overlap.

2. The aerosol generating device of claim 1, wherein the cartridge insertion hole is provided in one of the side surface or the second surface of the housing.

3. The aerosol generating device of claim 1, wherein the aerosol generating material comprises at least one of cut tobacco leaves, tobacco granules, reconstituted tobacco, or a liquid aerosol forming material containing nicotine.

4. The aerosol generating device of claim 1, wherein
the cartridge comprises a cartridge body surrounding an outer side of the aerosol generating material, and
the cartridge body comprises a porous material.

5. The aerosol generating device of claim 4, wherein
the cartridge further comprises a cartridge stopper disposed at one end of the cartridge body, and
at least a portion of the cartridge stopper extends more than the cartridge body, in a direction perpendicular to a direction in which the cartridge stopper and the cartridge body are arranged.

6. The aerosol generating device of claim 1, wherein the resonator comprises a first plate and a second plate disposed with the cartridge interposed therebetween.

7. The aerosol generating device of claim 1, further comprising:
a controller accommodated in the housing and configured to control an operation of the aerosol generating device, the controller comprising at least one processor; and
a battery accommodated in the housing and configured to supply power to the aerosol generating device.

8. The aerosol generating device of claim 1, further comprising:
a shielding portion surrounding the oscillator and the resonator,
wherein the shielding portion is provided with a shielding portion opening through which the cartridge is inserted, and
the shielding portion opening and the cartridge insertion hole are aligned side by side with each other.

9. The aerosol generating device of claim 1, further comprising:
an airflow path extending from an airflow inlet formed in one surface of the housing through the cartridge to the mouthpiece.

10. The aerosol generating device of claim 9, wherein the airflow inlet is formed in the side surface of the housing.

11. The aerosol generating device of claim 9, wherein the airflow inlet is formed in the second surface of the housing.

12. An aerosol generating device comprising:
a housing comprising a first surface, a second surface opposite to the first surface, a side surface between the first surface and the second surface, and a mouthpiece formed on the first surface;
an oscillator accommodated in the housing and configured to generate a microwave with a frequency in the range of 300 megahertz (MHz) to 300 gigahertz (GHz);
a resonator accommodated in the housing and configured to resonate the microwave to generate an amplified electromagnetic field; and
a cartridge comprising an aerosol generating material and being insertable into the housing,
wherein an aerosol is generated as at least a portion of the electromagnetic field heats the aerosol generating material,
the cartridge comprises a cartridge body surrounding an outer side of the aerosol generating material, and
the cartridge body comprises a porous material.

13. The aerosol generating device of claim 12, wherein the aerosol generating material comprises at least one of cut tobacco leaves, tobacco granules, reconstituted tobacco, or a liquid aerosol forming material containing nicotine.

14. The aerosol generating device of claim 12, wherein
the housing is provided with a cartridge insertion hole through which the cartridge is inserted, and
the cartridge insertion hole is provided in one of the side surface or the second surface of the housing.

15. The aerosol generating device of claim 12, further comprising:
an airflow path extending from an airflow inlet through the cartridge to the mouthpiece,
wherein the airflow inlet is formed in at least one of the side surface or the second surface of the housing.
